(19) United States
(12) Patent Application Publication
(10) Pub. No.: US 2011/0149056 A1
(43) Pub. Date: Jun. 23, 2011

(54) System and Method for Event Mapping and Analysis

(75) Inventors: Regina E. Dugan, McLean, VA (US); Thomas McVeigh, Shenandoah Junction, WV (US); Chad Mathias, Sykesville, MD (US)

(73) Assignee: REDXDEFENSE, LLC, Rockville, MD (US)

(21) Appl. No.: 12/969,932

(22) Filed: Dec. 16, 2010

Related U.S. Application Data
(60) Provisional application No. 61/289,167, filed on Dec. 22, 2009.

(51) Int. Cl. H04N 7/18; H04N 7/00

(52) U.S. Cl. 348/61; 348/552; 348/E07.085

(57) ABSTRACT

A system and method for event mapping and analysis utilizes a portable event logging device including a geo-locating device, a processor and a plurality of dedicated event logging keys associated with unique event states. In use, a user utilizes the dedicated event logging keys to record event state data, such as a positive detection of explosives residue. The event state data is recorded as an event specific data set with associated geographic location data from the geo-locating unit. Additional data, such as bar code data recorded by an indicia reader of the logging device, is stored with the event specific data set. A collection of event specific data sets is uploaded into a computer system where it is processed and presented in the form of a map to reveal patterns and trends in event states, such as the presence of explosives residue in a particular geographic region.

### CROSS-REFERENCE TO RELATED APPLICATIONS

The present application claims the benefit of U.S. Provisional Patent Application Ser. No. 61/289,167 entitled “Integrated Data Logging and Mapping,” filed Dec. 22, 2009.

### BACKGROUND OF THE INVENTION

1. Field of the Invention

The present invention pertains to the art of event analysis and, more particularly, to mapping and analyzing event occurrences within a specific geographic area.

2. Discussion of the Prior Art

In general, trends may be evaluated through the synthesis of data collected. For example, in the case of a viral or bacterial outbreak, data recorded at doctors' offices may be collected to assess an appropriate number of sick patients in a particular area. Telephone surveys may also be conducted, calling a representative number of households in a general area to acquire average data regarding sickness or other trends. In another example, changes in population may be accessed through hospitals' records on birth and death rates. A historical example when geo-located data proved useful was in preparation of John Snow's mapping of the cholera outbreak in London, England in 1854. John Snow, considered one of the fathers of modern epidemiology, interviewed residents in a large area of town to determine at which homes deaths had occurred, and subsequently plotted the deaths on a street map. The data revealed a higher concentration of deaths around a particular pump supplying water to the town. When the pump was turned off, the number of deaths quickly diminished.

In general, it is known to collect event data and later correlate the data with the location of the event on a digital map. For example, U.S. Patent Application Publication No. 2010/0198858 to Edwards et al. is directed to a system and methods for linking multiple events involving firearms and gang related activities. In general, Edwards et al. teaches entering firearm event data into a system database, generating a query report that gathers selected data from the system database, and performing an analysis of the query data. The query data can be presented in the form of a digital map.

The present invention is concerned with providing a system and method for recording and analyzing event occurrences at distinct geographic locations. The present invention allows for real-time data collection and analyses of localized event occurrences, such as the detection of explosives residue at various locations within a distinct geographic area.

### SUMMARY OF THE INVENTION

The present invention is directed to a system and method for event mapping and analysis. In general, the system of the present invention includes a portable event logging device and a computer system including a data processor, data storage device, user interface and user display. In a preferred embodiment, the system also includes a portable explosives detection device onto which the logging device is adapted to be removably attached. The logging device includes a geo-locating unit, a power switch, a plurality of dedicated event logging keys, a data storage unit and a power source. The logging device also preferably includes an indicia reader, such as an RFID reader, an image capture device, a display, a communications device and various actuations keys and status indicators.

In use, a user first obtains event specific data for a particular location, such as a positive test for explosives using the portable explosives detection device. The user then logs the specific event state data (e.g., positive explosives test result) into the logging device utilizing a corresponding dedicated event logging key. The logging device stores the event state data along with geographic location data provided by the geo-locating unit as an event specific data set. Optionally, evidence data or other data may be included with the event specific data set. For example, a sample sheet utilized in the detection of explosives residue can be sealed in an evidence container having a unique identifier thereon, such as a bar code. A user can utilize the indicia reader to scan unique identifier data from the bar code into the logging device and store the information with the correct event specific data set. Similarly, digital image data may be collected utilizing the image capture device. Event specific data sets stored within the logging device are uploaded into the computer system where they are processed for mapping and analysis. Upon request, a user visualizes the collected data sets on a digital geographic map utilizing a geographic information system (GIS). The user may then analyze the mapped data sets to reveal patterns and trends in event states, such as the prevalence of explosives residue in a particular geographic area of a town.

Additional objects, features and advantages of the present invention will become more readily apparent from the following detailed description of the preferred embodiments when taken in conjunction with the drawings wherein like reference numerals refer to corresponding parts in the several views.

### BRIEF DESCRIPTION OF THE DRAWINGS

FIG. 1 a combination perspective and schematic view of a preferred system of the present invention;

FIG. 2 is an exploded view of a logging device and explosives detection device combination;

FIG. 3A is a side perspective view of the logging device of the present invention;

FIG. 3B is a front perspective view of the logging device of FIG. 3A;

FIG. 4 is a schematic of a preferred method of utilizing the system of the present invention;

FIG. 5 is an illustrative example of a computer screen shot showing data storage options;

FIG. 6 is an illustrative example of a computer screen shot showing data editing options;

FIG. 7 is an illustrative example of a computer screen shot showing mapped data points; and

FIG. 8 is an illustrative example of a computer screen shot showing event specific data associated with a mapped data point.

### DETAILED DESCRIPTION OF THE PREFERRED EMBODIMENTS

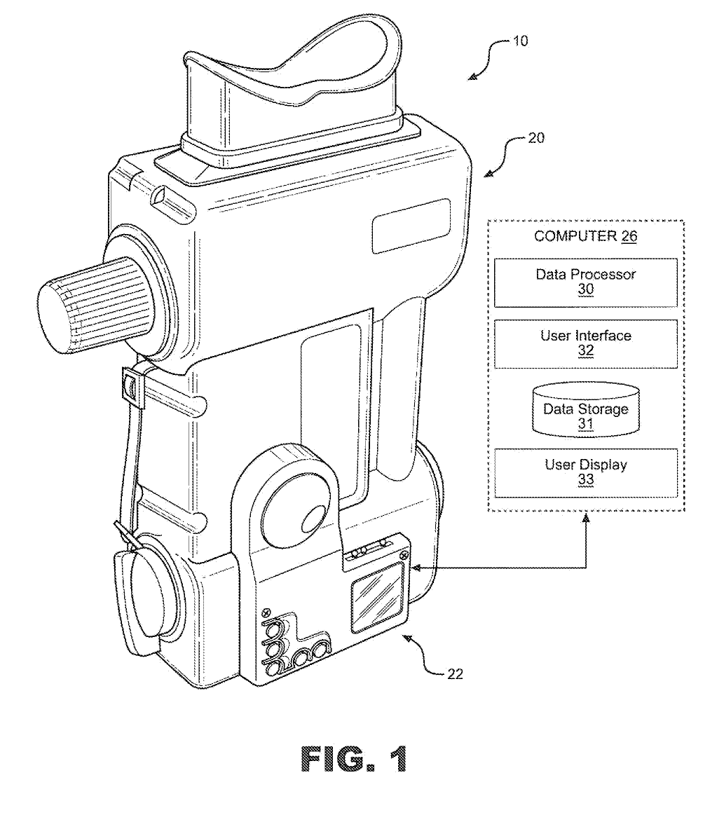

With initial reference to FIG. 1, a preferred system for event mapping and analysis in accordance with the present invention is generally depicted at 10. In the first embodiment shown, system 10 includes a portable explosives detection device 20, a portable event logging device 22, and a computer 26 including a data processor 30, a data storage device 31, a user interface 32 such as a keyboard or the like, and a display 33 such as an LCD computer monitor. As will be discussed in more detail below, system 10 is preferably utilized in the collection, mapping and analysis of location-specific explosives data. Specific components of system 10 are discussed in more detail below.

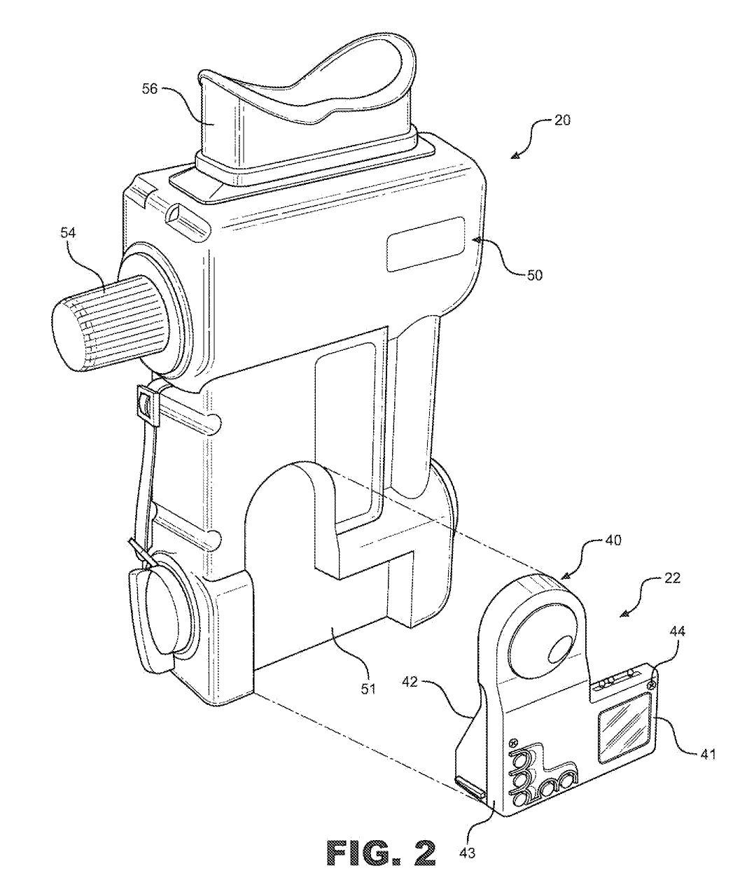

As depicted in FIG. 2, logging device 22 includes a main housing 40 having a front face portion 41, a back wall portion 42 and a side wall portion 43. Preferably, main housing 40 is in the form of a two-part shell fastened together by screws 44 or the like. In one embodiment, logging device 22 is removably mounted to detection device 20 by fasteners (not shown), such as screws or the like. More specifically, detection device 20 preferably includes a main housing 50 including a logging device engagement portion 51 contoured to substantially directly abut back wall portion 42 of logging device 22, as well as at least a part of side wall portion 43. Detection device 20 is preferably a housing-modified version of the fully integrated portable screening system described in co-pending U.S. patent application Ser. No. 11/525,509 filed Sep. 22, 2006 and published as U.S. Patent Application Publication No. 2010/0240143, which is hereby incorporated by reference. With this preferred embodiment, detection device 20 includes a removable contact pad or baton 54 including sample sheets (not shown) and a view finder 56. In general, a trace sample is collected utilizing a sample sheet wrapped around baton 54, the sample sheet is exposed to a test medium or activating solution(s), and an application system (not shown) within main housing 50 delivers a test reagent to the sample sheet. A testing mechanism, preferably in the form of an ultraviolet light source (not shown) within main housing 50 is activated, and an operator peers through view finder 56 to determine the presence of a chemical reaction indicating the detection of an explosives residue. In accordance with this preferred embodiment, detection device 20 may be easily transported to various locations in order to produce real-time test results indicating the presence or absence of explosives residue. Specific testing regimes preferably include those disclosed in co-pending U.S. patent application Ser. No. 12/442,160 filed Mar. 20, 2009 and published as U.S. Patent Application Publication No. 2009/0246881, which is hereby incorporated by reference.

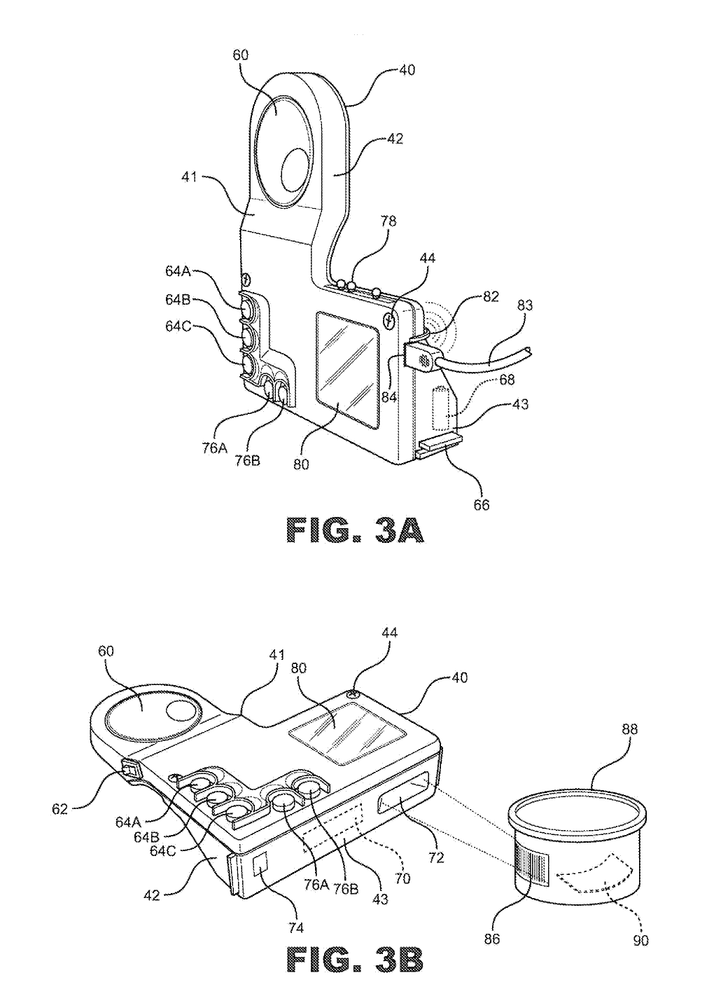

Additional details of logging device 22 will now be discussed with reference to FIGS. 3A and 3B. Logging device 22 is shown including a geo-locating unit indicated at 60, a power switch 62, a plurality of dedicated event logging keys 64a-64c, a data storage unit 66, a power source indicated at 68 and a data processor indicated at 70. Geo-locating unit 60 may be in the form of a Global Positioning System (GPS) receiver, an assisted GPS receiver, or a global system for mobile communications (GSM). Preferably, power source 68 is in the form of one or more rechargeable batteries, such as lithium ion or alkaline batteries, however power source 68 may also constitute an AC power source. Any desired number of dedicated event logging keys may be utilized, however, in the preferred embodiment, the number of possible event states is limited to three in order to facilitate ease of operation. Although depicted as push buttons, it should be understood that dedicated event logging keys 64A-64C are meant to encompass any type of standard user actuator such as switches, one or more dials, a touch pad, or any combination of actuators providing a means for selecting between one of a plurality of unique event states. Data storage unit 66 may be in the form of a solid state memory unit such as Flash memory, a removable memory device, or an internal hard drive, for example. Additionally, logging device 22 preferably includes an indicia reader 72, such as a bar-code scanner or radio-frequency identification (RFID) reader, an image capture device such as a digital camera indicated at 74, camera and indicia reader actuation keys 76A, 76B, status indicators 78, a user display 80 and a communications device generally indicated at 82. In one embodiment, logging device 22 includes mapping software enabling a user to view the current geographic location of logging device 22 on display 80. Although shown incorporated with logging device 22, digital camera 74 can alternatively be separate from logging device 22, in which case digital camera 74 includes a communications line or other communications device enabling communication with logging device 22 and/or computer 26 such that digital photographic or video data can be transferred between camera 74 and logging device 22 and/or computer 26.

Status indicators 78 are preferably light emitting diodes (LEDs) indicating various states such as power-on, GPS fix, indicia reader status (e.g., scanner ready or scan successful) and other data capture or logging states. Communications device 82 is shown including a wireless device, as well as a power and communications cable 83 such as a universal serial bus (USB) cable, Ethernet cable or the like, and an associated port 84. However, it should be understood that communications device 82 could be in the form of a wireless communication device only, may be combined with data storage device 66 in the form of a removable memory device, such as a disk drive, a thumb drive, a SD card, a mini-SD card or a micro-SD card which can be used to transfer data in a manner known in the art, or may comprise other known communication devices or combinations of devices. When in the form of a removable memory card, data storage device 66 advantageously provides expandable permanent data storage and flexibility in data transfer operations by removing dependencies upon external data network infrastructures such as those infrastructures used by a wireless data interface. Wireless data transfer methods for use with the present invention include radio, Bluetooth or 802.11 based communication standards, or the like. With respect to indicia reader 72, in the preferred embodiment indicia reader 72 is configured to recognize a unique identifier 86, such as a bar code or RFID tag, associated with a sample or evidence container 88. As described in more detail below, evidence container 88 can be utilized to store a used sample sheet 90, or other evidence associated with event specific data.

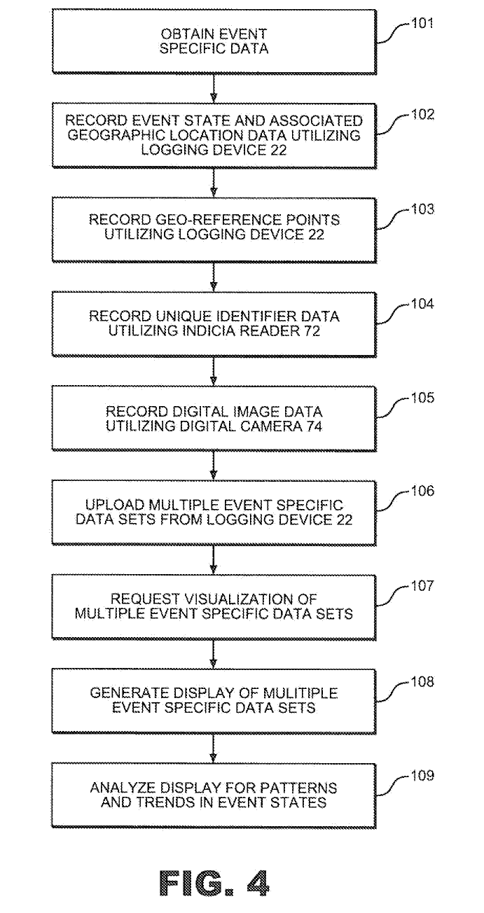

The preferred manner in which system 10 is utilized will now be described with reference to FIG. 4. Initially, a user will obtain event specific data for a particular location as indicated at 101. In the preferred embodiment, the event specific data comprises a selection of unique event state options associated with the detection of explosives. For example, an event state may be selected from the group:

(a) nitrogen-based explosives such as nitroaromatic, nitramine and organic nitrate-based explosives were detected;

(b) the presence or absence of nitrogen-based explosives was not determined; and

(c) nitrogen-base explosives were not detected.

Each of the dedicated event logging keys 64A, 64B, 64C is assigned to one of the three types of event states (a)-(c) listed above. In order to log event specific data, a user simply pushes the dedicated event logging key 64A, 64B, 64C assigned to the proper event state observed at a particular location as indicated at 102. For example, a user may analyze a sample sheet utilizing the detection device 20, and finding no explosives residue, will push dedicated event logging key 64C to record the observation that no nitrogen-based explosives were found at that particular location. Processor 70 enables logging device 22 to store this event state data in data storage device 66, along with associated geographic location data (from geo-locating unit 60) of the logging device 22 at the time the event state was recorded. Geographic location data may be in the form of meta-data associated with the event state data or may be otherwise associated with the event state data. In a preferred embodiment, the event state logging function is disabled if geo-locating unit 60 is unable to provide the associated geographic location data, such as during a malfunction of the geo-locating unit 60. Such a malfunction is preferably communicated to a user through one of status indicators 78. In a preferred embodiment, logging device 22 enables a user to mark specific geo-reference points at a location in order to correct for any inaccuracies in third party geographic data (e.g., GPS or GIS data) as indicated at 103. For example, logging device 22 may be programmed such that pressing two of the dedicated event logging keys 64A-64C at the same time will cause logging device 22 to record a reference point, such as the location of a landmark in the vicinity of the logging event. For example, it should be understood that by marking each corner of a building being investigated, a user may correct for discrepancies in mapping information, such as satellite imaging data, by aligning the satellite building image data with reference point data for the building recorded on-site with logging device 22.

During the course of data collection, it may become desirable to collect samples or other types of evidence associated with a particular logging event 102. For example, in the case of positive explosives detection, a user will push dedicated event logging key 64A to record the presence of explosives residue in a particular location. As depicted in FIG. 3B, a used sample sheet 90 indicating the presence of explosives can be sealed in container 88, which includes unique identifier 86. A user then logs the unique identifier data by pushing indicia reader actuation key 76B to scan in data from unique identifier 86 using indicia reader 72. Logging device 22 automatically associates the unique identifier data with the event specific data set for that location (e.g., the event state data and geographic location data), as indicated at step 104 in FIG. 4. In another embodiment, indicia reader 72 is utilized to scan barcodes located on shipping packages in order to track explosives screening of individual shipping packages.

Additional evidence may be collected in the form of digital image data using digital camera 74 as indicated at 105. For example, in the case where explosives residue was collected from the trunk of a vehicle, a digital photograph may be taken of the license plate or other identifying characteristics of the vehicle by pushing camera actuation key 76A. Digital camera 74 may also be used to further document a particular event state, such as the presence or absence of explosives contamination on a sample sheet. As with the unique indicia logging function, logging device 22 automatically associates the digital image data with the prior event specific data set logged by the user at that particular location. In this way, evidence data collected on-site is stored as an event specific data set within data storage device 66 for a particular location, such that all evidence data, including any unique identifier and digital image data, may be easily retrieved and viewed in context at a later date. Data stored in data storage unit 66 is preferably in a standardized format such as Extensible Markup Language (XML) for compatibility with other data analysis and visualization systems, or Keyhole Markup Language (KML) for compatibility with the Google Earth™ GIS. Geo-location data should be understood to include location information that may be translated by data processor 30 to common geo-spatial standards, such as latitude/longitude and Military Grid Reference System. In addition to specific event data and evidence data, data logging device 22 may also be programmed to record other information such as the date and time of the data logging event, the name of the logging device 22 operator, and a designation of the data logging device used to capture the data (e.g., digital camera or indicia reader).

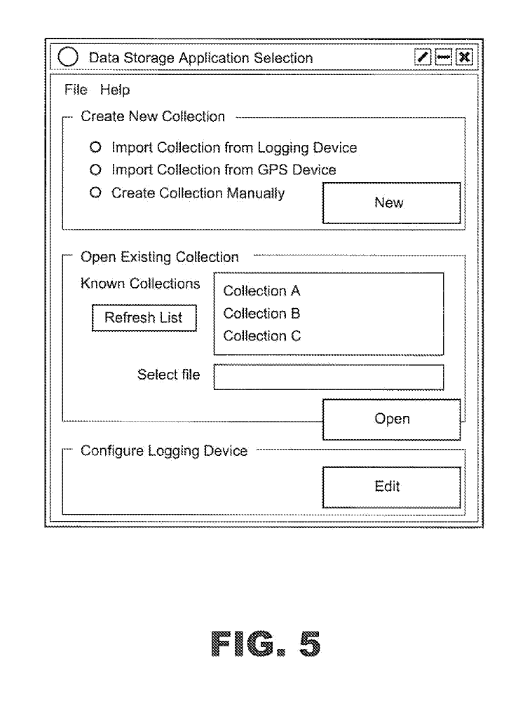

As can be understood from the discussion above, logging device 22 records event specific data sets for particular geographic locations, which can be combined to provide a geographic data set for a particular geographic area. A user may then analyze the data set to reveal patterns and trends in mapped event specific data. In a preferred embodiment, data stored within data storage device 66 is uploaded into centralized computer 26 for data processing, analysis and visualization of data as indicated at 106. Data processing may include the use of algorithms for identifying trends in data. An illustrative computer screen shot is depicted in FIG. 5, showing various importing options. Data collected from a particular logging device 22 is preferably imported, although data may also be manually entered into computer 26 or imported from another device, such as a separate digital camera or GPS device. Data transfer can be accomplished utilizing a USB port, Ethernet port, or other communications device 82 which allows for physical connection to computer 26, by transfer of data directly through a removable data card or the like, or by wireless transfer of data. In one embodiment, communications device 82 is in the form of a wireless data transfer device which avoids the need for a physical connection and enables remote, real-time data uploading to centralized data storage device 31 during data logging events, such as explosives screening events. It should be easily understood that data from multiple logging devices 22 may be imported into computer 26 such that data from various locations and logging devices are available to a user. Advantageously, this real-time multiple input device capability enables data to be processed and analyzed by data processor 30 in near real-time, thus revealing trends in the data during active data logging events, and enabling a user to infer changes in the data collection and logging operations to optimize data collected practices.

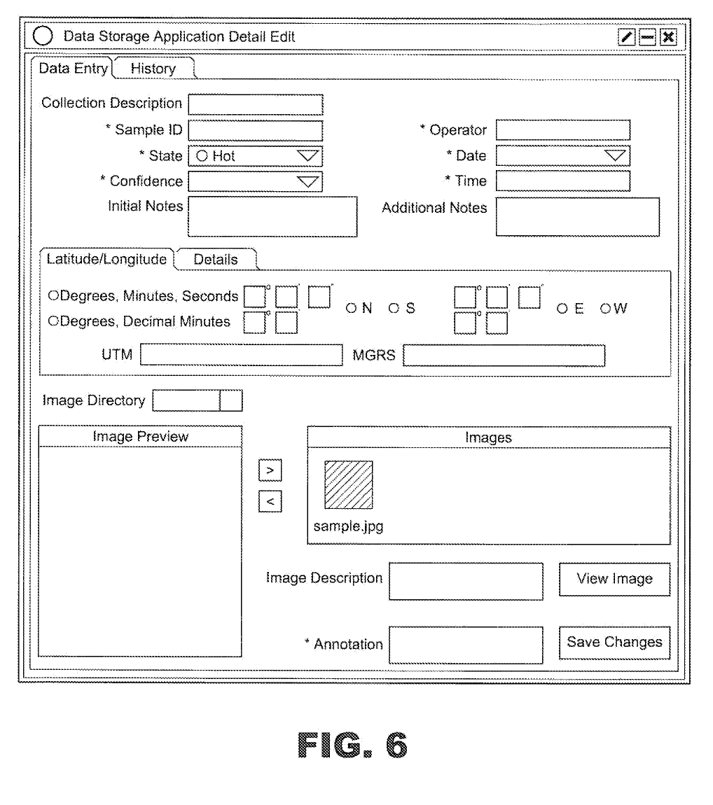

Data processor 30 includes software that enables the presentation of data from a plurality of logging devices 22 in discreet collections, a single collection, or a combination of discreet and combined collections. Preferably, data storage 31 of computer 26 maintains data collections (multiple event specific data sets), and data processor 30 enables the data collections to be edited, deleted, or displayed on display 33. An illustrative computer screen shot in FIG. 6 depicts various data fields in which data may be entered or edited. For example, event specific data may be edited to include operator entered comments or notes. Data fields specific to the type of data stored (e.g., indicator of explosives, digital image data, unique identifier data) may be fixed or alterable. For example, a field for user notes associated with an explosives detection event may be alterable, while data indicating that explosives were detected is fixed. In one embodiment, alterations to data automatically require a user to include an explanation for the alteration to be recorded along with all the other event specific data. Additionally, or, alternatively, an audit trail may be implemented to automatically track changes to data.

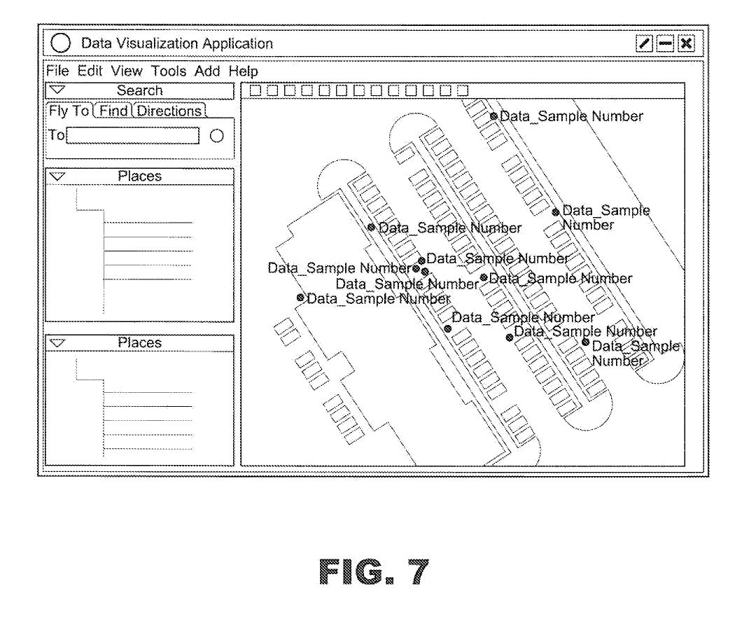

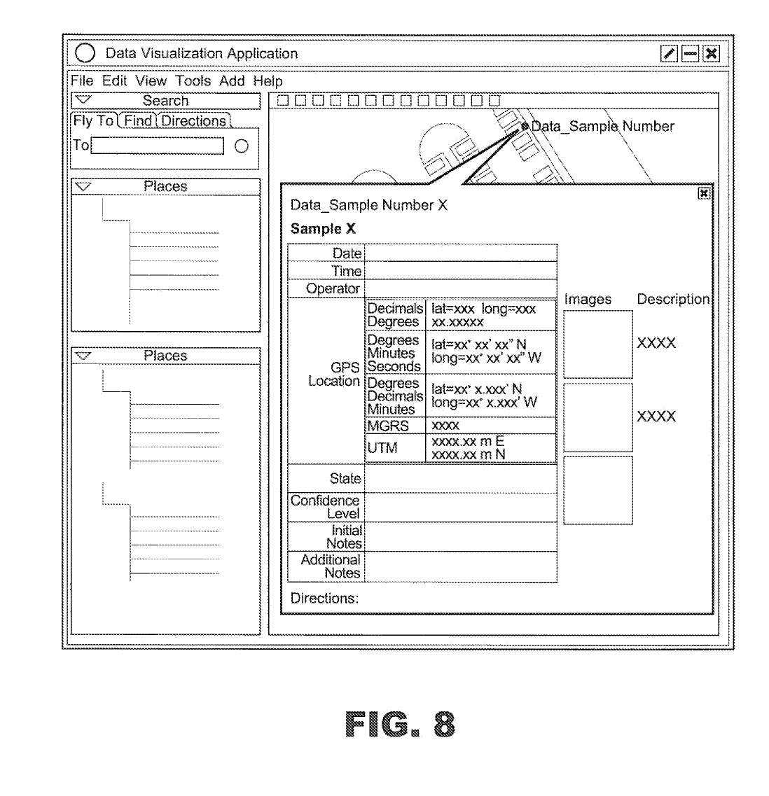

As previously discussed, system 10 preferably provides a means for visualizing collected data using an external GIS. In the preferred embodiment, when an operator requests visualization of collected data sets, the GIS is started and event specific data collection points that make up the collected data sets are displayed, as indicated at 107 and 108 in FIG. 4. This collective display of individual data points reveal patterns and trends that are useful to the operator, as indicated at 109. FIG. 7 is an illustrative computer screen shot of mapped event specific data sets downloaded from multiple logging devices 22. In the preferred use of logging device 22, the presence of trace explosives within a specified geographic region is logged and mapped using color coding to reveal possible terrorist hot spots, such as bomb-making facilities. For example, locations where explosives are detected show up in red on the generated digital map, while locations where no explosives are found show up in green, and locations where no clear indication is determined show up in yellow. As depicted in FIG. 8, each mapped geo-location point can be selected by a user in order to bring up all data associated with a particular event specific data set.

System 10 may be suitable for a wide range of applications. Although discussed mainly with reference to explosives detection, it should be recognized that logging device 22 is not limited to use with explosives detection devices. For example, in an alternative embodiment, logging device 22 is used in a medical surveillance system in order to provide patterns that indicate epicenters of disease and illness outbreaks. For example, a user may push dedicated event logging key 64A to indicate that infection was found at a particular site, dedicated event logging key 64B to indicate that no infection was found, and dedicated event logging key 64C to indicate that a death has occurred as a result of an infection. In another embodiment, logging device 22 may be used in a narcotic detection system in order to provide patterns that indicate centers of commerce for illicit drug trafficking or may provide data on other criminal activity. For example, dedicated event logging keys 64A-64B may be associated with various types of criminal activity, such as larceny or assault. It should be easily understood that digital images captures by digital camera 74 may serve as further evidence of location specific event states and may assist in additional activities, such as forensic or intelligence operations. In the case of health-related data logging, digital camera 74 may be utilize to document evidence of an illness, such as images of a sick person or an image of the event location, such as a home address. Similarly, biomedical cultures collected may be placed inside a sealed container 88 labeled with a unique identifier 86, and the unique identifier data stored in data logging device 22 with other event specific data for a particular location.

Although described with reference to preferred embodiments of the invention, it should be readily understood that various changes and/or modifications can be made to the invention without departing from the spirit thereof. For example, system 10 may be configured to work with additional types of data-gathering equipment or tools, such as infrared data or environmental data such as temperature. In general, the invention is only intended to be limited by the scope of the following claims.

1. A system for event mapping and analysis comprising:
a portable event logging device including:
a housing;
a power source;
a geo-locating unit for determining a geographic location of the portable event logging device and providing geographic location data;
a data storage unit adapted to store a plurality of data sets;
a plurality of dedicated event logging keys located on the housing, each of the dedicated event logging keys being associated with a unique event state and enabling a user to record event state data in the data storage unit;
a processor enabling the event state data to be recorded with associated geographic location data from the geo-locating unit as an event specific data set; and
a computer system including:
a user interface;
a display;
a data storage device adapted to receive the event specific data set from the data storage unit of the portable event logging device; and
a data processor adapted to process the event specific data set received from the data storage unit and present information to a user in the form of a map of the event specific data set.

2. The system of claim 1, further comprising, in combination:
a portable explosives detection device adapted to provide a user with test results indicating the presence or absence of explosives residue; and
wherein the unique state associated with one of the plurality of dedicated event logging keys is the presence of explosives residue and the unique state associated with another of the plurality of dedicated event logging keys is the absence of explosives residue.

3. The system of claim 1, wherein the portable event logging device further comprises an indicia reader adapted to identify indicia data provided by a unique identifying indicia and an indicia reader actuation key for actuating said indicia reader; and wherein the processor further enables the indicia data to be recorded in the data storage unit in a manner which links the indicia data with associated event state data.

4. The system of claim 3, wherein the indicia reader is selected from the group consisting of a bar-code reader and a radio frequency identification reader.

5. The system of claim 3, further comprising a sealable container including the unique identifying indicia.

6. The system of claim 1, wherein the portable event logging device further comprises a digital camera adapted to capture image data and a digital camera actuation key for actuating said digital camera; and wherein the processor further enables the image data to be recorded in the data storage unit in a manner which links the image data with associated event state data.

7. The system of claim 1, wherein the portable event logging device further comprises a plurality of status indicators adapted to inform a user of various states of the portable event logging device.

8. The system of claim 1, wherein the data storage device of the portable event logging device is removable and configured to directly transfer data stored therein to the computer system.

9. The system of claim 1, wherein the portable event logging device further comprises a wireless communications device configured to wirelessly transfer data stored in the data storage unit to the computer system.

10. A portable event logging device comprising:
a housing;
a power source;
a geo-locating unit for determining a geographic location of the portable event logging device and providing geographic location data;
a data storage unit adapted to store a plurality of data sets;
a plurality of dedicated event logging keys located on the housing, each of the dedicated event logging keys being associated with a unique event state and enabling a user to record event state data in the data storage unit; and
a processor enabling the event state data to be recorded with associated geographic location data from the geo-locating unit as an event specific data set.

11. The portable event logging device of claim 10, further comprising an indicia reader adapted to identify indicia data provided by a unique identifying indicia and an indicia reader actuation key for actuating said indicia reader; wherein the processor further enables the indicia data to be recorded in the data storage unit in a manner which links the indicia data with associated event state data.

12. The portable event logging device of claim 11, wherein the indicia reader is selected from the group consisting of a bar-code reader and a radio frequency identification reader.

13. The portable event logging device of claim 10, further comprising a digital camera adapted to capture image data and a digital camera actuation key for actuating said digital camera; wherein the processor further enables the image data to be recorded as part of the event specific data set.

14. The portable event logging device of claim 10, further comprising a plurality of status indicators adapted to inform a user of various states of the portable event logging device.

15. The portable event logging device of claim 10, wherein the data storage device is removable.

16. The portable event logging device of claim 10, further comprising a wireless communications device configured to wirelessly transfer data stored in the data storage unit.

17. A method for event mapping and analysis utilizing a portable event logging device including a housing, a power source, a geo-locating unit, a data storage unit, a plurality of dedicated event logging keys associated with unique event states, and a processor, the method comprising the steps of
(a) obtaining information indicating one of a plurality of unique event states;
(b) obtaining geographic location data using the geo-locating unit;
(c) obtaining an actuation signal from a respective one of the plurality of dedicated event logging keys associated with the one of the plurality of unique event states;
(d) recording an event specific data set in the data storage unit, the event specific data set including the geographic location data and the one of the plurality of unique event states; and
(e) repeating steps (a)-(d) to record multiple event specific data sets in the data storage unit.

18. The method of claim 17, wherein the event specific data set of step (d) further includes unique identifier data associated with a unique identifier, wherein the unique identifier data is obtained using an indicia reader incorporated in the portable event logging device.

19. The method of claim 17, wherein the event specific data set of step (d) further includes digital image data, wherein the digital image data is obtained using a digital image capture device incorporated in the portable event logging device.

20. The method of claim 17, further comprising:
(f) uploading the multiple event specific data sets from the data storage unit into a remote data storage system;
(g) processing the multiple event specific data sets utilizing a known geographical information system; and
(h) displaying a map of the multiple event specific data sets.
